(19) United States
(12) Patent Application Publication
(10) Pub. No.: US 2003/0047162 A1
(43) Pub. Date: Mar. 13, 2003

(54) Fuel injection valve

(76) Inventors: Peter Schramm, Knetzgau (DE); Stefan Lauter, Markgroeningen (DE)

Correspondence Address: KENYON & KENYON, ONE BROADWAY, NEW YORK, NY, 10004, US

(21) Appl. No.: 10/089,833

(22) PCT Filed: Jul. 19, 2001
(86) PCT No.: PCT/DE01/02711

(30) Foreign Application Priority Data
Aug. 5, 2000 (DE) 10038301.7

(51) Int. Cl. F02M 57/04

(52) U.S. Cl. 123/296; 123/294

(57) ABSTRACT

A fuel injector (1) for direct injection of fuel into a combustion chamber of an internal combustion engine has at least one retaining flange (5) situated on a nozzle body (2) of the fuel injector (1). The retaining flange (5) projects radially above the nozzle body (2), and a hold-down device may act on it. The retaining flange (5) may rest on a cylinder head of the internal combustion engine. The retaining flanges (5) extend over only portions of the periphery of the nozzle body (2).

### BACKGROUND INFORMATION

The present invention relates to a fuel injector according to the preamble of claim 1.

Unexamined Japanese Patent Application 08-312503 A describes a fuel injector having a peripheral collar, the bottom of which may be placed on the top of the cylinder head. The fuel injector may be held in a receptacle bore by a hold-down device against a relatively high combustion pressure prevailing in a combustion chamber of the internal combustion engine. The hold-down acts on the collar at two opposing locations on the periphery of the fuel injector.

One disadvantage of this fuel injector is that a slim, compact design of the fuel injector is impossible, because the peripheral collar requires a great width of the fuel injector.

German Patent 44 13 415 C1 describes a fuel injector having seating surfaces for a hold-down device in diametrically opposed positions, not distributed over the entire periphery of the nozzle body of the fuel injector. These seating surfaces are formed by recesses in the nozzle body. Therefore, the seating surfaces are inside the periphery of the nozzle body radially.

One disadvantage of this fuel injector according to the related art is that the hold-down forces transmitted to the seating surfaces are supported by the nozzle body.

German Patent Application 197 35 665 A1 also describes a fuel injector having a collar on which a hold-down device acts. A cylinder head has a recess in which the collar of the fuel injector is situated, so that the collar of the fuel injector, acted upon by the hold-down device is countersunk in the cylinder head. This fuel injector also does not have a compact design.

### ADVANTAGES OF THE INVENTION

The fuel injector according to the present invention having the features of claim 1 has the advantage over the related art that it permits a slim, compact design of the fuel injector and at the same time allows the hold-down forces to be dissipated without transmitting these forces through the nozzle body.

Advantageous refinements of the fuel injector characterized in claim 1 are possible through the measures characterized in the subclaims.

### DRAWING

An embodiment of the present invention is illustrated in the drawing and explained in greater detail in the following description.

FIG. 1 shows a partial side view of an embodiment of a fuel injector according to the present invention, and

FIG. 2 shows a top view of the embodiment of a fuel injector according to the present invention, illustrated in FIG. 1.

### DESCRIPTION OF THE EXEMPLARY EMBODIMENT

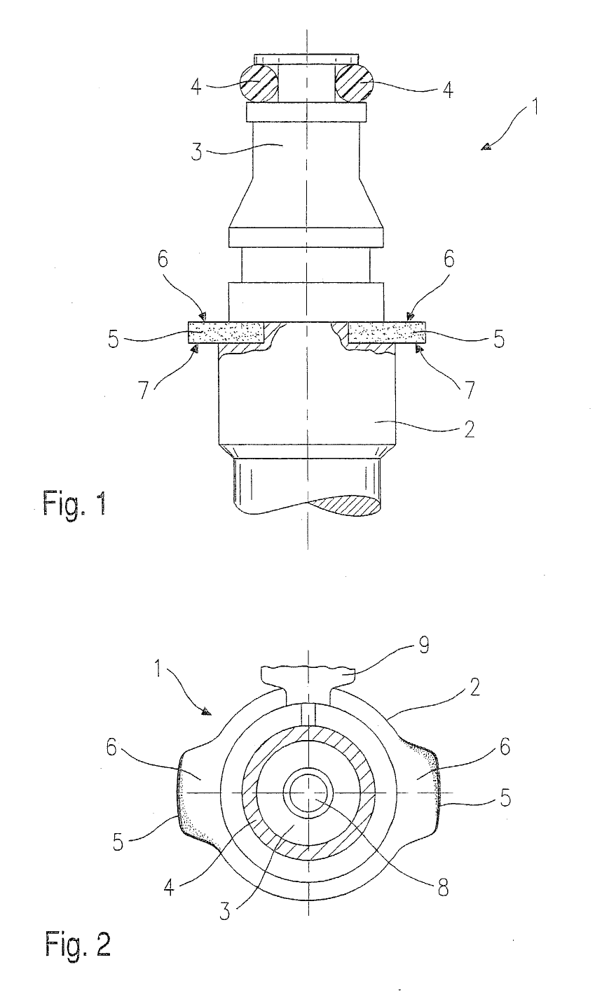

FIG. 1 shows a fuel injector 1, showing only the section at the inlet end. Fuel injector 1 has a nozzle body 2 and an inlet connection 3 on its inlet end. A sealing ring 4, shown here in a sectional view, seals inlet connection 3 from a fuel inlet (not shown). Retaining flanges 5 which project radially beyond nozzle body 2 and on which a hold-down device may act on a working surface 6 of retaining flanges 5 are situated on nozzle body 2. Retaining flanges 5 may rest on a seating surface 7 of a cylinder head of an internal combustion engine, for example. According to the present invention, retaining flanges 5 extend over only a portion of the periphery of nozzle body 2.

FIG. 2 shows a top view of fuel injector 1 according to the present invention from FIG. 1. Inlet connection 3 is located upstream from nozzle body 2. Sealing ring 4 is mostly covered by inlet connection 3. An inlet bore 8 is situated centrally in inlet connection 3. In addition, a portion of a connector 9 which connects a controller to fuel injector 1, which has an energizable actuator. Two retaining flanges 5 are situated opposite one another on the periphery of nozzle body 2. Two retaining flanges 5 each take up an angle range of approx. 45°, for example, in the peripheral direction. For example, connector 9 may extend at a distance of 90° from both retaining flanges 5. In the diagram shown here, of retaining flanges 5, only working surfaces 6 for a hold-down device are visible.

Fuel injector 1 is pressed by a tension claw of the hold-down device, which, pressed into a receptacle bore in the cylinder head, presses on working surfaces 6. Lower seating surfaces 7 rest on the cylinder head and support the hold-down force.

Therefore, it is possible for very high hold-down forces to be applied without them having to be diverted through nozzle body 2. Since retaining flanges 5 extend over only part of the periphery, fuel injector 1 has a very slim and compact design. Retaining flanges 5 may also be used to align fuel injector 1 with respect to the cylinder head and the combustion chamber.

Retaining flanges 5 may be separate parts which are joined by welding or in a force-locking or friction-locking manner (FIG. 1) or they may be shaped in one piece with nozzle body 2 by removal of material, e.g., machining (FIG. 2). Alternatively, retaining flanges 5 may be formed in one piece by reshaping from the material of nozzle body 2.

In particular, with fuel injector 1 according to the present invention, no additional component is necessary for attaching a tension claw, such as a pressure sleeve which is mounted on fuel injector 1. Through an appropriate design of the tension claw, fuel injector 1 may also be secured on retaining flanges 5 to prevent twisting in its receptacle bore.

What is claimed is:

1. A fuel injector (1) for direct injection of fuel into a combustion chamber of an internal combustion engine, having at least one retaining flange (5), which is situated on a nozzle body (2) of the fuel injector (1) and projects radially beyond the nozzle body (2), which has a working surface (6) for a hold-down device and is positionable on a seating surface (7) on a cylinder head of the internal combustion engine,
wherein the retaining flange (5) extends over only a portion of the periphery of the fuel injector (1).

2. The fuel injector according to claim 1,
wherein there are two retaining flanges (5) situated opposite one another.

3. The fuel injector according to claim 1 or 2,
wherein each retaining flange (5) is manufactured as a separate component and is joined to the nozzle body (2) in an integral or friction-locking manner.

4. The fuel injector according to claim 3,
wherein each retaining flange (5) is welded to the nozzle body (2).

5. The fuel injector according to claim 1 or 2,
wherein each retaining flange (5) is designed in one piece with the nozzle body (2).

6. The fuel injector according to one of claims 1 through 5,
wherein the retaining flanges (5) each cover an angular range of approx. 45° in the peripheral direction.
